(19) United States
(12) Patent Application Publication
(10) Pub. No.: US 2014/0310413 A1
(43) Pub. Date: Oct. 16, 2014

(54) METHOD FOR MANAGING A USER TERMINAL THROUGH A NETWORK ON THE BASIS OF OPERATING SPEED INFORMATION ON THE USER TERMINAL, AND WEB SERVER USED FOR SAME

(71) Applicant: GOOD FRIEND, Ulsan (KR)

(72) Inventor: Sung-Hyun Jung, Ulsan (KR)

(21) Appl. No.: 14/358,700

(22) PCT Filed: Oct. 15, 2012
(86) PCT No.: PCT/KR2012/008360

§ 371 Date: May 15, 2014

(30) Foreign Application Priority Data
Nov. 15, 2011 (JP) 10-2011-0118885

(51) Int. Cl. H04L 12/24; H04L 12/26

(52) U.S. Cl. CPC H04L 41/32; H04L 43/065
USPC 709/224

(57) ABSTRACT

The present invention relates to a method for managing a user terminal through a network, and to a web server used for same. The present invention is implemented by a web server which: receives from each user terminal speed information including the speed of the hardware installed in the users terminal, the speed of the software installed in the user terminal, or the Internet speed for the user terminal; sets a reference speed value for each user terminal on the basis of the speed information; and determines whether maintenance of the user terminal is necessary on the basis of the received current speed information on the user terminal and the reference speed value. According to the present invention, optimal management is enabled in consideration of the performance properties of each user terminal by remotely managing the user terminal in a state where the reference speed value is individually set according to the performance of a plurality of user terminals.

### TECHNICAL FIELD

The present invention relates to a method for managing a user terminal through a network and a web server used for the same, and more particularly, to a method for managing a user terminal through a network which may not only perform preventive management of the user terminal and save management time and costs of the user terminal before the user terminal has a serious problem, but also perform customized management in consideration of performance characteristics of individual user terminals, and a web server used for the same.

### BACKGROUND ART

When a PC widely used in an office, a public office, a home, and the like has problems, such as a fault of accessory equipment, a network disorder, a virus infection, or the like, a user or an external manager needs to fix the PC.

Generally, the user of the PC may not accurately know data values for a state of the PC to which he/she is using, or even though he/she knows the data values, may not properly use the data values, such that he/she does not recognize problems which increasingly occur in his/her PC and does not recognize a problem until his/her PC fails to operate and requires maintenance.

That is, according to the related art, the user cannot but be unguardedly exposed to a performance degradation of a PC, various types of virus infections, a risk of hacking, and a data loss before a serious problem has occurred in his/her PC.

Meanwhile, since even management and maintenance enterprises of PCs of each user do not secure data regarding a state change of consumer's PCs, they may not accurately diagnose that the corresponding PC has a problem for some reason, and therefore repair the PCs only on the basis of a general experience of a PC manager, such that maintenance costs and time may excessively occur due to an exchange of unnecessary parts.

Therefore, a need exists for customized management in consideration of individual performance of each PC at the time of managing PCs of each user.

### SUMMARY OF THE INVENTION

### [Problems to be Solved by the Invention]

Accordingly, it is an object of the present invention to provide a method for managing a user terminal through a network which may not only perform preventive management of the user terminal and save management time and costs of the user terminal before the user terminal has a serious problem, but also perform customized management in consideration of performance characteristics of individual user terminals and a web server used for the same.

### [Means for Solving the Problems]

According to an embodiment of the present invention, there is provided a method for managing a user terminal through a network, including: (a) receiving, by a web server, speed information on each user terminal from each user terminal in which a user terminal monitoring program is installed to transmit the speed information which is information including at least one of a speed of hardware of the user terminal which is first measured in the state in which it is installed in each user terminal, a speed of software installed in the user terminal, and an Internet speed for the user terminal connected to the web server; (b) storing, by the web server, the speed information on each user terminal received from each user terminal; (c) setting, by the web server, reference speed values for each user terminal on the basis of the speed information; (d) receiving, by the web server, current speed information on each user terminal which is the information including at least one of the speed of hardware of the user terminal, the speed of software installed in the user terminal, and the Internet speed for the user terminal; and (e) determining, by the web server, whether each user terminal needs to be repaired on the basis of the current speed information on each user terminal and the reference speed values for each user terminal.

In step (a), the speed of hardware may be a time taken to repeatedly carry out a predetermined operation a predetermined number of times, the speed of software may be a time taken to repeatedly carry out a predetermined command a predetermined number of times, and the Internet speed may be a speed to receive data from the web server in the user terminal.

In step (c), the reference speed value may be set on the basis of a maximum value of an average speed of the speed of hardware, the speed of software, and the Internet speed.

The reference speed value may be a value reduced by a predetermined ratio from the maximum value of the average speed.

In step (d), the current speed information may be the speed information which is transmitted to the web server by the monitoring program when power is applied to the user terminal.

According to another embodiment of the present invention, there is provided a web server, including: a receiving unit configured to receive speed information on each user terminal from each user terminal in which a user terminal monitoring program is installed to transmit the speed information which is information including at least one of a speed of hardware of the user terminal which is first measured in the state in which it is installed in each user terminal, a speed of software installed in the user terminal, and an Internet speed for the user terminal connected to a web server; a storage unit configured to store the speed information on each user terminal received from each user terminal; and

a determination unit configured to set reference speed values for each user terminal on the basis of the speed information, wherein the receiving unit receives current speed information on each user terminal which is the information including at least one of the speed of hardware of the user terminal, the speed of software installed in the user terminal, and the Internet speed for the user terminal, and the determination unit determines whether each user terminal needs to be repaired on the basis of the current speed information on each user terminal and the reference speed values for each user terminal.

The speed of hardware may be a time taken to repeatedly carry out a predetermined operation a predetermined number of times, the speed of software may be a time taken to repeatedly carry out a predetermined command a predetermined number of times, and the Internet speed may be a speed to receive data from the web server in the user terminal.

The determination unit may set the reference speed value on the basis of a maximum value of an average value of the speed of hardware, the speed of software, and the Internet speed.

The reference speed value may be a value reduced by a predetermined ratio from the maximum value of the average speed.

The current speed information may be the speed information which is transmitted to the web server by the monitoring program when power is applied to the user terminal.

### [Advantageous Effects]

According to the present invention, the state information on each user terminal may be acquired at ordinary times to perform the preventive management of the user terminal before the user terminal has a serious problem, as well as the manager may repair and manage the user terminal on the basis of the accurate state information of the user terminal to reduce the management time and costs.

Further, according to the present invention, the user terminal may be remotely managed in the state in which the reference speed values determined on the basis of the performance for each of a plurality of user terminals are individually set, thereby optimally managing the user terminals in consideration of the performance characteristics of each user terminal.

### BRIEF DESCRIPTION OF THE DRAWINGS

FIG. 1 is a schematic view illustrating a structure of a diagnostic system of a user terminal through a network according to the present invention.

FIG. 2 is a functional block diagram of a web server used in the diagnostic system of a user terminal through a network according to the present invention.

FIG. 3 is a flow chart describing a procedure of a method for managing a user terminal through a network according to an embodiment of the present invention.

### MODES FOR CARRYING OUT THE INVENTION

Hereinafter, embodiments of the present invention will be described in more detail with reference to the accompanying drawings. It is to be noted that throughout the drawings, like components are denoted by like reference numerals if possible. In the embodiments of the present invention, a detailed description of publicly known functions and configurations that are judged to be able to make the purport of the present invention unnecessarily obscure are omitted.

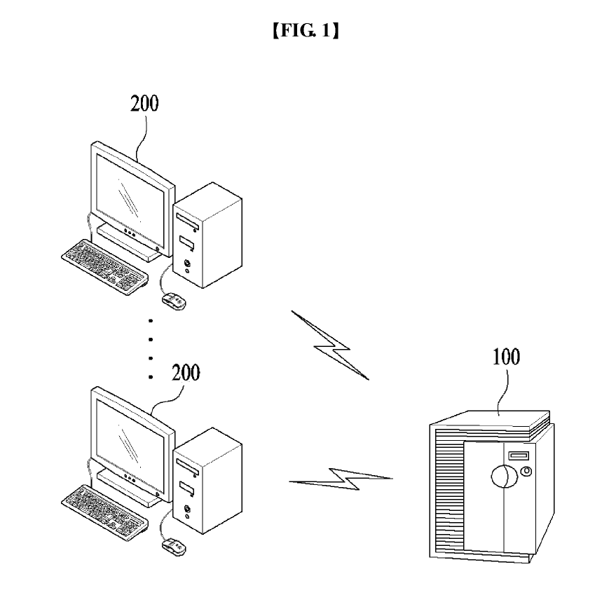

FIG. 1 is a schematic view illustrating a structure of a diagnostic system of a user terminal through a network according to the present invention. Referring to FIG. 1, a diagnostic system of a user terminal 200 through a network according to the present invention includes at least one user terminal 200 and a web server 100.

In FIG. 1, the user terminal 200 may be various PCs which are installed in an office, a public office, a home, or the like, in which the user terminal 200 transmits its own speed information to the web server 100 in the state in which the user terminal 200 is connected to the web server 100 through the network, and the web server 100 determines whether the user terminal 200 needs to be repaired on the basis of speed information received from the user terminal 200.

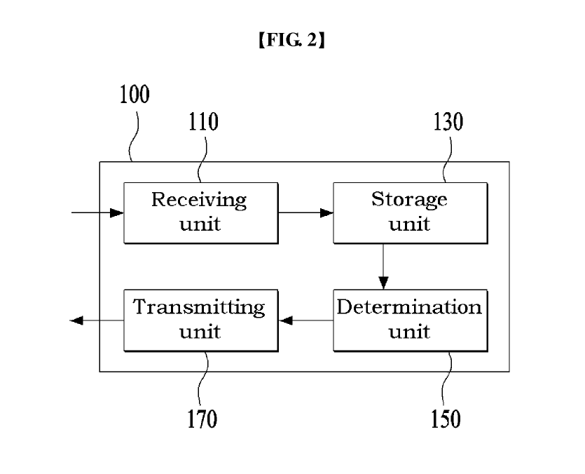

FIG. 2 is a functional block diagram of the web server used in the diagnostic system of a user terminal through a network according to the present invention. Referring to FIG. 2, the web server 100 according to the present invention includes a receiving unit 110, a storage unit 130, a determination unit 150, and a transmitting unit 170.

In detail, the receiving unit 110 receives the speed information of the user terminal 200 from the user terminal 200, and the storage unit 130 stores the speed information received by the receiving unit 110.

Meanwhile, the determination unit 150 determines whether the user terminal 200 needs to be repaired on the basis of the speed information received from the user terminal 200, and the transmitting unit 170 transmits a maintenance notification message to the user terminal 200 if it is determined that the user terminal 200 needs to be repaired by the determination unit 150.

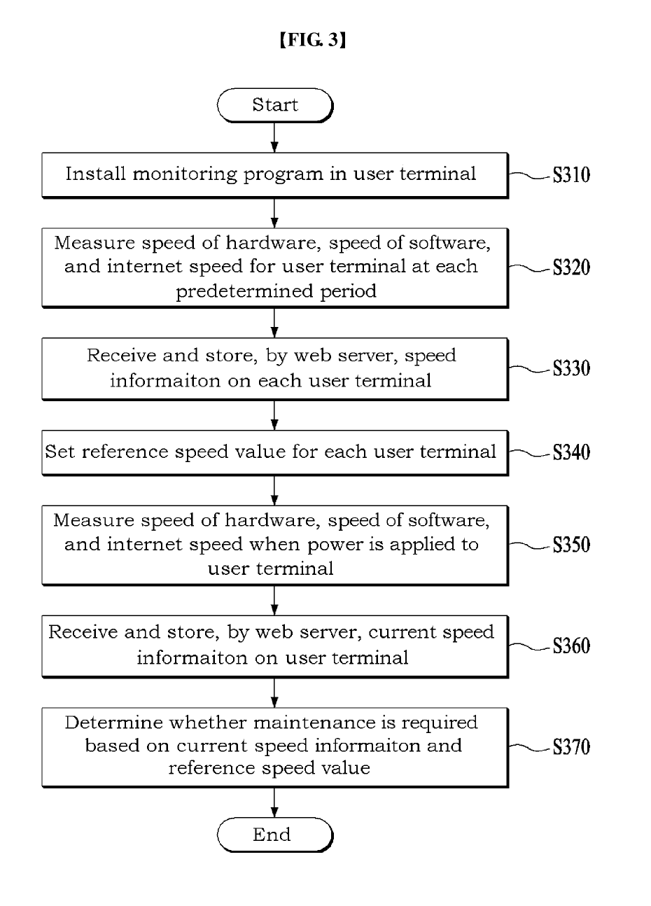

FIG. 3 is a flow chart describing a procedure of a method for managing a user terminal through a network according to an embodiment of the present invention. Describing a method for managing the user terminal 200 through a network according to the embodiment of the present invention with reference to FIGS. 1 to 3, a manager installs a monitoring program in each user terminal 200 to be managed by the manager (S310).

In this configuration, when the monitoring program is installed in each user terminal 200, the speed information, which is information including at least one of a speed of hardware of the user terminal 200, a speed of software installed in the user terminal 200, and an Internet speed for the user terminal 200, is first measured, and then the speed information of the user terminal 200 is periodically measured (S320).

In detail, for the monitoring program to measure the speed of hardware, the speed of software, and the Internet speed for the user terminal 200, the following method may be used.

Method for Measuring Speed of Hardware V_{H}

In order to measure the speed of hardware according to the embodiment of the present invention, the monitoring program measures an operation speed of a central processing unit (CPU) on the basis of a method for obtaining a ratio of the circumference of a circle to its diameter (π). In detail, among various approaches for obtaining the ratio of the circumference of a circle to its diameter (π), a statistical approach method referred to as a ‘Monte Carlo Simulation’ which will be described below is used.

1. First, one quadrant is drawn in a square about one apex.

2. In this case, when the entire width of the square is 1, a width of a circle becomes π/4.

3. Next, a computer generates a random number, and dots are randomly marked in the square based on the generated random number.

4. Then, a distance between the apexes of the square is calculated, and whether the dots are inside or outside the quadrant is determined based on the calculated distance.

5. For example, when a total of 100,000 dots are marked, if n dots among the 100,000 dots are present in the quadrant, it may be predicted that a ratio of two numbers, that is, a value of n/ 100,000 approximates π/4 which is a ratio of the width.

6. As the experiment proceeds by marking a larger number of dots, the value is more precise.

Alternatively, in order to measure the speed of hardware according to the present invention, the monitoring program may measure the speed of hardware on the basis of the time taken for the central processing unit of the user terminal 200 to repeatedly carry out any operation (for example, an operation of multiplying numbers from 1 to 100) a predetermined number of times.

Method for Measuring Speed of Software V_{S}

In order to measure the speed of the PC, the monitoring program generates a virtual camera using software for generating and editing a three-dimensional (3D) object which is installed in the user terminal 200 and measures the time taken to carry out commands which generate the 3D object, set a material thereof, rotate the 3D object, or the like.

As described above, for a user to recognize the measured value, the measured value is repeatedly generated several times to derive a figure of an integer unit that the user may easily recognize and thus is used as the speed value of software V_{S}.

Method for Measuring Internet Speed V_{I}

In order to measure the Internet speed, the monitoring program is connected to the web server 100 through TCP/IP socket communications and then measures the time taken to download a specific file stored in the storage unit 130 of the web server 100 to the user terminal 200.

In this case, a value, which is obtained by converting a download speed [capacity (byte)÷download time (S)] calculated on the basis of the capacity (byte) of the downloaded file and the downloading time S into Mbps, is calculated as the Internet speed V_{I}.

Meanwhile, according to the embodiment of the present invention, a standardized Internet speed V_{I}′ based on the following Equation 1 may also be used.

$${V}_{I}^{′} = \frac{{V}_{I} s ( 63 - {V}_{I} )}{10} \qquad [ Equation 1 ]$$

Meanwhile, the method for measuring a speed of hardware, a speed of software, and an Internet speed which are described above is based on a standardization operation method and if necessary, may change substitution equations for each user terminal 200 to be measured to carry out a more precise measurement.

Next, the monitoring program transmits the measured speed information of the user terminal 200 to the web server 100, and the receiving unit 110 of the web server 100 receives the speed information on each user terminal 200 and individually stores the received speed information (S330).

Therefore, the determination unit 150 of the web server 100 sets reference speed values for each user terminal 200 on the basis of the stored speed information on each user terminal 200, and stores the set reference speed values in the storage unit 130 of the web server 100 (S340).

Meanwhile, in order to set the reference speed values for each user terminal 200 by the determination unit 150 of the web server 100, the following Equation 2 is used.

$$P = \frac{{V}_{H} + {V}_{S} + {V}_{I}}{3} \qquad [ Equation 2 ]$$

In Equation 2, P represents the reference speed value, V_{H} represents the speed of hardware, V_{S} represents the speed of software, and V_{I} represents the Internet speed. For example, when the speed of hardware is 8 seconds, the speed of software is 2 seconds, and the Internet speed is 2 seconds, the reference speed value becomes 4 seconds.

Meanwhile, according to the embodiment of the present invention, in order to set the reference speed values for each user terminal 200 by the determination unit 150 of the web server 100, it is preferable to set, as the reference speed value, a maximum value among average speed values which are calculated by substituting the speed value of hardware, the speed value of software, and the Internet speed value, which are received at each predetermined period from the user terminal 200 for a predetermined period which is a period set for the reference speed value, into the above Equation 2.

Further, according to the embodiment of the present invention, in order to set the reference speed values for each user terminal by the determination unit 150 of the web server 100, it is preferable to set, as the reference speed value, a value reduced by a predetermined ratio (for example, 10%) from the maximum value among the average speed values which are calculated by substituting the speed value of hardware, the speed value of software, and the Internet speed value, which are received at each predetermined period from the user terminal 200 for the predetermined period which is the period set for the reference speed value, into the above Equation 2.

Next, the monitoring programs which are installed in each user terminal 200 measures at least one of the speed of hardware of the user terminal 200, the speed of software installed in the user terminal 200, and the Internet speed for the user terminal 200 at an arbitrarily set time such as a power application time of the user terminal 200, and transmits the at least one measured value to the web server 100 as current speed information (S350).

Therefore, the receiving unit 110 of the web server 100 periodically receives the current speed information from each user terminal 200 and the received current speed information on each user terminal 200 is stored in the storage unit 130 of the web server 100 (S360).

Meanwhile, the determination unit 150 of the web server 100 determines whether each user terminal needs to be repaired based on the current speed information which is received and stored for each user terminal 200 and the reference speed values which are previously stored in the storage unit 130 for each user terminal 200 (S370).

In detail, when the average value of the speed value of hardware, the speed value of software, and the Internet speed value which are included in the current speed information received for each user terminal 200 is smaller than the reference speed value which is set as the value reduced by the predetermined ratio (for example, 10%) from the maximum value among the average speed values which are calculated by substituting the speed value of hardware, the speed value of software, and the Internet speed value, which are received at each predetermined period from the user terminal 200 for the predetermined period which is the period set for the reference speed value, into the above Equation 2, it is determined that a maintenance of the corresponding user terminal 200 is required.

Hereinabove, although embodiments and applications of the present invention are illustrated and described, the present invention is not limited to the above-described embodiment and an application range is various and it is apparent that various modifications can be made to those skilled in the art without departing from the spirit of the present invention described in the appended claims and the modified embodiments are not to be individually understood, but instead understood in terms of the technical spirit and potential of the present invention.

Further, terms used in the present specification are used only in order to describe specific embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or any combination thereof, but do not preclude the presence or addition of one or more other features, numerals, steps, operations, components, parts, or any combination thereof.

### INDUSTRIAL APPLICABILITY

Industrial applicability of the present invention is recognized in computer related industrial fields.

1. A method for managing a user terminal through a network, comprising:
(a) receiving, by a web server, speed information on each user terminal from each user terminal in which a user terminal monitoring program is installed to transmit the speed information which is information including at least one of a speed of hardware of the user terminal which is first measured in the state in which it is installed in each user terminal, a speed of software installed in the user terminal, and an Internet speed for the user terminal;
(b) storing, by the web server, the speed information on each user terminal received from each user terminal;
(c) setting, by the web server, reference speed values for each user terminal on the basis of the speed information;
(d) receiving, by the web server, current speed information on each user terminal which is the information including at least one of the speed of hardware of the user terminal, the speed of software installed in the user terminal, and the Internet speed for the user terminal; and
(e) determining, by the web server, whether each user terminal needs to be repaired on the basis of the current speed information on each user terminal and the reference speed values for each user terminal.

2. The method of claim 1, wherein in step (a), the speed of hardware is a time taken to repeatedly carry out a predetermined operation a predetermined number of times,
the speed of software is a time taken to repeatedly carry out a predetermined command a predetermined number of times, and
the Internet speed is a speed to receive data from the web server in the user terminal.

3. The method of claim 1, wherein in step (c), the reference speed value is set on the basis of a maximum value of an average speed of the speed of hardware, the speed of software, and the Internet speed.

4. The method of claim 3, wherein the reference speed value is a value reduced by a predetermined ratio from the maximum value of the average speed.

5. The method of claim 1, wherein in step (d), the current speed information is the speed information which is transmitted to the web server by the monitoring program when power is applied to the user terminal.

6. A web server, comprising:
a receiving unit configured to receive speed information on each user terminal from each user terminal in which a user terminal monitoring program is installed to transmit the speed information which is information including at least one of a speed of hardware of the user terminal which is first measured in the state in which it is installed in each user terminal, a speed of software installed in the user terminal, and an Internet speed for the user terminal;
a storage unit configured to store the speed information on each user terminal received from each user terminal; and
a determination unit configured to set reference speed values for each user terminal on the basis of the speed information,
wherein the receiving unit receives current speed information on each user terminal which is the information including at least one of the speed of hardware of the user terminal, the speed of software installed in the user terminal, and the Internet speed for the user terminal, and
the determination unit determines whether each user terminal needs to be repaired on the basis of the current speed information on each user terminal and the reference speed values for each user terminal.

7. The web server of claim 6, wherein the speed of hardware is a time taken to repeatedly carry out a predetermined operation a predetermined number of times, the speed of software is a time taken to repeatedly carry out a predetermined command a predetermined number of times, and the Internet speed is a speed to receive data from the web server in the user terminal.

8. The web server of claim 6, wherein the determination unit sets the reference speed value on the basis of a maximum value of an average value of the speed of hardware, the speed of software, and the Internet speed.

9. The web server of claim 8, wherein the reference speed value is a value reduced by a predetermined ratio from the maximum value of the average speed.

10. The web server of claim 6, wherein the current speed information is the speed information which is transmitted to the web server by the monitoring program when power is applied to the user terminal.
